(19) United States
(12) Patent Application Publication
(10) Pub. No.: US 2014/0006149 A1
(43) Pub. Date: Jan. 2, 2014

(54) NOTIFYING CUSTOMERS POST-TRANSACTION OF ALTERNATIVE PAYMENT TYPES ACCEPTED BY A MERCHANT

(71) Applicants: David M. Grigg, Rock Hill, SC (US); Alicia C. Jones, Fort Mill, SC (US); Matthew A. Calman, Charlotte, NC (US); Susan Smith Thomas, Gastonia, NC (US)

(72) Inventors: David M. Grigg, Rock Hill, SC (US); Alicia C. Jones, Fort Mill, SC (US); Matthew A. Calman, Charlotte, NC (US); Susan Smith Thomas, Gastonia, NC (US)

(73) Assignee: Bank of America Corporation, Charlotte, NC (US)

(21) Appl. No.: 13/536,808

(22) Filed: Jun. 28, 2012

(51) Int. Cl. G06Q 20/22; G06Q 30/02

(52) U.S. Cl. 705/14.51; 705/35

(57) ABSTRACT

Systems, methods, and computer program products are provided provide for notifying customers, post-transaction, of additional payment types accepted by the merchant and, in some embodiments, an option to change the payment type to one of the additional payment types. As such, the present invention serves to make the customer aware of new and emerging payment types, such as specific mobile payment types, that the customer may otherwise be unaware of their acceptance by the merchant. In addition, the merchant may provide and notify the customer of benefits (e.g., discounts, rebates/cash-back or the like) for using one of the additional payment types for a future transaction, thereby, enticing the customer to use the new and emerging payment type.

### FIELD

In general, embodiments herein disclosed relate to commerce and, more specifically, electronically notifying customers of alternative payment types accepted by a merchant after the customers have conducted a transaction using another payment type.

### BACKGROUND

Mobile payment, also referred to as mobile money, mobile banking or mobile wallet, allows for the user/customer to conduct a transaction (i.e., pay for goods or services) using their mobile communication device as the payment vehicle as opposed to conventional means for payment (e.g., cash, credit/debit card, check or the like). Many different types of mobile payment are currently in use or will be in use in the future. For example, short range wireless communication, such as Near Field Communication (NFC), Wi-Fi, Bluetooth® or the like, allows for mobile payment via mobile communication device's equipped with requisite short range wireless communication functionality, such as a NFC chip (or some other close-range wireless protocol chip). The NFC or other short range wireless functionality provides for the mobile communication device to wirelessly exchange payment credentials in a secure environment with a corresponding point-of sale (POS) terminal, which is also configured with the requisite short range wireless functionality.

In another example, visual indicia exchange may be implemented between the mobile communication device and the payment terminal. For example, the POS terminal may display a computer readable-indicia, for example a code, such as a barcode, Quick Response (QR) code or the like, which is captured by the mobile communication device via an image capture mechanism (i.e., a camera or the like) embodied with the mobile communication device. In response to receipt and processing of the computer readable-indicia, the mobile communication device will communicate payment credentials to the POS. In specific example, the mobile communication device may generate and display another computer readable-indicia, which includes the customer's payment credentials and is subsequently captured by the POS terminal.

In a related example, computer readable-indicia may be implemented in conjunction with cloud storage of the customer's credentials. In such an example, the POS terminal may display computer readable-indicia, such as a barcode, Quick Response (QR) code or the like, which is captured by the mobile communication device and provides for the mobile communication device to connect with the cloud. Once the mobile and the POS terminal have connected with the cloud, secure key exchange provides the authentication for the customer's payment credentials to be communicated form the cloud storage to the POS terminal.

The various different mobile payment types all require the mobile communication device and/or the related payment applications to perform functions that are specific to the mobile payment type. For example, Short-range communication, such as NFC requires activation of the short-range/NFC chip for broadcasting such communications, indicia capturing requires activation of the image capturing device (i.e., camera) and the like. In practice, the customer may be unaware of which type(s) of mobile payment type a merchant accepts until they are about to conduct the payment transaction (i.e., at that the POS terminal). An inefficiency is realized in terms of overall transaction time, if the customer is required to manually configure the mobile communication device for mobile payment of the type accepted by the retailer when the customer is about to conduct a transaction (i.e., at the POS terminal). Moreover, if the customer, within a short period of time, is unable to manually configure their mobile communication device at the POS terminal, the customer may forego a mobile payment and resort to conventional payment means (i.e., cash, check, credit/debit or the like).

Moreover, with an advent of new payment types, customers may often be unaware of different types of payment, mobile or otherwise, accepted by merchant. Unless the customer is made aware of the merchant's acceptance of alternative payment types; through employees, signage, advertisement/marketing, or the like, the customer is apt to continue to make payment using conventional payment types, such as credit/debit card, check, cash or the like. In addition, the customer is often unaware of which payment type is most beneficial to the customer, for example, which payment type currently offers discounts, cash-back, extended warranty coverage or the like.

Therefore, a need exists for notifying customers of alternative payment types accepted by merchants and the associated benefits which the customer may realize by using the alternative payment types in the future.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Apparatus, methods and computer program products are defined that provide for notifying customers of alternative payment types accepted by a merchant after a customer has completed a transaction using another payment type. In one example, the customer may conduct a transaction at a merchant using a credit/debit card as the payment type and subsequently the customer is sent a notification, such as a text, email or the like, that notifies the customer of one or more non-conventional payment types, such as one or mobile payment (otherwise referred to as, mobile wallet, mobile money or the like) types accepted by the merchant. The notification may also include an option for the customer to change the payment type in the just completed transaction to one of the payment types indicated in the notification.

In addition to notifying the customer of additional payment types accepted by the merchant, the invention may also provide for determining benefit(s) associated with using the additional payment types (e.g., discounts, extended warranty protection, other incentives and the like) for one or more future transactions with the merchant and including such in the customer notification. Moreover, in additional embodiments of the invention, an optimal payment type may be determined from amongst the additional payment types. The optimal payment type may be based on the benefit(s) associated with the payment type and/or the amount of the presently completed transaction or the item(s) included in the presently conducted transaction.

An apparatus configured for notifying a customer, post-transaction, of additional payment types accepted by a merchant defines first embodiments of the invention. The apparatus includes a computing platform including a memory and at least one processor in communication with the memory. The apparatus further includes a payment type notification module that is stored in the memory and executable by the processor. The payment type notification module is configured to determine that a customer has conducted a transaction with a merchant using a first payment type and determine one or more additional payment types accepted by the merchant, each additional payment type being different than the first payment type. The payment notification module is further configured to, in response to determination of the one or more additional payment types, generate and communicate a notification to the customer that indicates at least one of the additional payment types.

In other embodiments of the apparatus, the payment notification type module is further configured to generate and communicate the notification that includes an option for the customer to change the first payment type to one of the additional payment types for the completed transaction. In such embodiments, the payment notification type module may be further configured to receive a customer input that initiates a change from the first payment type to one of the additional payment types for the completed transaction.

In further embodiments of the apparatus, the payment type notification module is further configured to determine at least one mobile payment type included in the one or more additional payment types and, in response to determination of the at least one mobile payment type, generate and communicate a notification to the customer that indicates the at least one mobile payment type.

In other embodiments of the apparatus, the payment type notification module is further configured to determine a benefit to be realized by the customer using one of the additional payment types and, in response to determination of the benefit, generate and communicate the notification to the customer that further indicates the benefit associated with an additional payment type indicated in the notification. Further, in such embodiments the benefit may include, but is not limited to, a discount with the merchant, a cash-back incentive with the merchant or additional warranty coverage. In related embodiments the benefit may be a customer-specific benefit determined by accessing customer profile accounts, transaction history data, payment account data or the like.

In still further embodiments of the apparatus, the payment type notification module is further configured to determine an optimal payment type from amongst the one or more additional payment types. In such embodiments of the apparatus, the payment type notification module may be further configured to, in response to determination of the optimal payment type, generate and communicate the notification to the customer that indicates the optimal payment type and a reason why the optimal payment type is optimal. In such embodiments of the apparatus, the optimal payment type may be based on the benefit(s) associated with the payment type, the item type(s) in the currently completed transaction or the payment amount for the currently completed transaction.

In yet other embodiments of the apparatus, the payment type notification module is further configured to generate and communicate the notification to the customer proximate in time to the transaction, such as contemporaneous communication of a text message, an email or the like.

A method notifying customers of payment types accepted by a merchant defines second embodiments of the invention. The computer-implemented method includes determining that a customer has conducted a transaction with a merchant using a first payment type and determining one or more additional payment types accepted by the merchant, each additional payment type being different than the first payment type. The method further includes, in response to determination of the one or more additional payment types, generating and initiating communication of a notification to the customer that indicates at least one of the additional payment types.

In other embodiments of the method, generating further includes generating and initiating communication of the notification that includes an option for the customer to change from the first payment type to another payment type for the just completed transaction. In such embodiments, the method may also include receiving a customer input that changes the first payment type to one of the additional payment types for the completed transaction.

In further embodiments of the method, determining one or more additional payment types further includes determining at least one mobile payment type and generating and initiating communication further includes, in response to determination of the at least one mobile payment type, generating and initiating communication of a notification to the customer that indicates the at least one mobile payment type.

In still further embodiments the method includes determining a benefit to be realized by the customer using one of the additional payment types. In such embodiments of the method generating and initiating communication further includes generating and initiating, in response to determination of the benefit, the notification to the customer that further indicates the benefit associated with the additional payment type indicated in the notification. In such embodiments the benefit may include, but is not limited to, a discount with the merchant, a cash-back incentive with the merchant or additional warranty coverage. In related embodiments of the method, determining the benefit may include determining a customer-specific benefit to be realized by the customer using the additional payment type. The customer-specific benefit may be realized by accessing a customer profile, customer transaction history data, customer account data or the like and applying applicable benefit rules.

In still further embodiments the method includes determining an optimal payment type from amongst the one or more additional payment types. In such embodiments of the method, generating and initiating communication of the notification may include in response to determination of the optimal payment type, generating and initiating communication, by the computing device processor, of the notification to the customer that indicates the optimal payment type and a reason why the optimal payment type is optimal. In such embodiments the optimal payment type may be based on the benefit(s) associated with the payment type, the item type(s) in the currently completed transaction or the payment amount for the currently completed transaction.

A computer program product including a non-transitory computer-readable medium defines third embodiments of the invention. The computer-readable medium includes a first set of codes for causing a computer processor device to determine that a customer has conducted a transaction with a merchant using a first payment type. The computer-readable medium additionally includes a second set of codes for causing a computer processor device to determine one or more additional payment types accepted by the merchant, wherein each additional payment type is different than the first payment type. The computer-readable medium additionally includes a third set of codes for causing a computer processor device to, in response to determination of the one or more additional payment types, generate and initiate communication of a notification to the customer that indicates at least one of the additional payment types.

Thus, as described in more details below, apparatus, methods and computer program products are defined that provide for notifying customers, post-transaction of additional payment types accepted by the merchant. In specific embodiments the notification includes an option for the customer to change the payment type for the completed transaction to one of the additional payment types. As such, the present invention serves to make the customer aware of new and emerging payment types, such as specific mobile payment types, that the customer may otherwise be unaware of their acceptance by the merchant. In addition, the merchant may provide benefits (e.g., discounts, rebates/cash-back or the like) to the customer for using one of the additional payment types for a future transaction, thereby, enticing the customer to use the new and emerging payment type. Moreover, in those embodiments in which the notification of additional payment types includes an optimal payment type, the customer benefits from being provided information as to which payment type should be used in the future so as to optimize the customer's transaction in terms of benefits or the like.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a schematic diagram of a system for automatically activating mobile payment mechanisms based on automated identification of the mobile payment types accepted by a merchant, in accordance with one embodiment of the present invention;

FIG. 2 is a block diagram of a mobile communication device configured for automatic activation of mobile payment mechanisms based on automated identification of the mobile payment types accepted by a merchant, in accordance with one embodiment of the present invention;

FIG. 3 is a flow diagram of a method for automatically activating mobile payment mechanisms based on automated identification of the mobile payment types accepted by a merchant, in accordance with an embodiment of the present invention;

FIG. 4 is a block diagram of an apparatus configured for notifying a customer, post-transaction, of other payment types accepted by a merchant, in accordance with embodiments of the present invention; and

FIG. 5 is a flow diagram of a method for notifying customers, post-transaction, of other payment types accepted by the merchant, in accordance with an embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media, including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Thus, systems and computer program products are defined that provide for automatic activation of mobile payment mechanisms (e.g., software applications, devices/hardware and the like) on a mobile communication device in response to automated determination of the mobile payment types accepted by a merchant at which the user/consumer is located. In one embodiment location determining mechanisms, such as Global Positioning System (GPS) devices are implemented on the mobile communication device to determine the geographic location of the mobile determine and identify a merchant/retailer associated with the location. Once the merchant has been identified, the mobile communication network communication determines the mobile payment type(s) accepted by the merchant by accessing an internally stored mobile payment type database or a network-based mobile payment type database. In response to determining the mobile payment type(s) accepted by the merchant, the mobile communication device automatically activates the mobile payment mechanisms associated with mobile payment type.

In this regard, the present invention serves to make the user/consumer aware of an option for a conducting a transaction using the mobile payment type(s) accepted by the merchant. In addition, the mobile payment transaction is made more efficient, in that, the user/consumer does not have to manually configure and/or activate the software or hardware associated with the mobile payment type.

In addition, apparatus, methods and computer program products and described which provide for notifying customers of alternative payment types accepted by a merchant after a customer has completed a transaction using another payment type. In one example, the customer may conduct a transaction at a merchant using a credit/debit card as the payment type and subsequently the customer is sent a notification, such as a text, email or the like, that notifies the customer of one or more non-conventional payment types, such as one or mobile payment (otherwise referred to as, mobile wallet, mobile money or the like) types accepted by the merchant. In addition to notifying the customer of additional payment types accepted by the merchant, the notification may include an option for the customer to change the payment type for the completed transaction to one of the additional payment types. Moreover, embodiments of the invention may also provide for determining benefit(s) associated with using the additional payment types (e.g., discounts, extended warranty protection, other incentives and the like) for the just completed transaction and/or for future transactions with the merchant and including such in the customer notification. Moreover, in additional embodiments of the invention, an optimal payment type for the just completed transaction and/or future similar transactions may be determined from amongst the additional payment types. The optimal payment type may be based on the benefit(s) associated with the payment type and/or the amount of the presently completed transaction or the item(s) included in the presently conducted transaction.

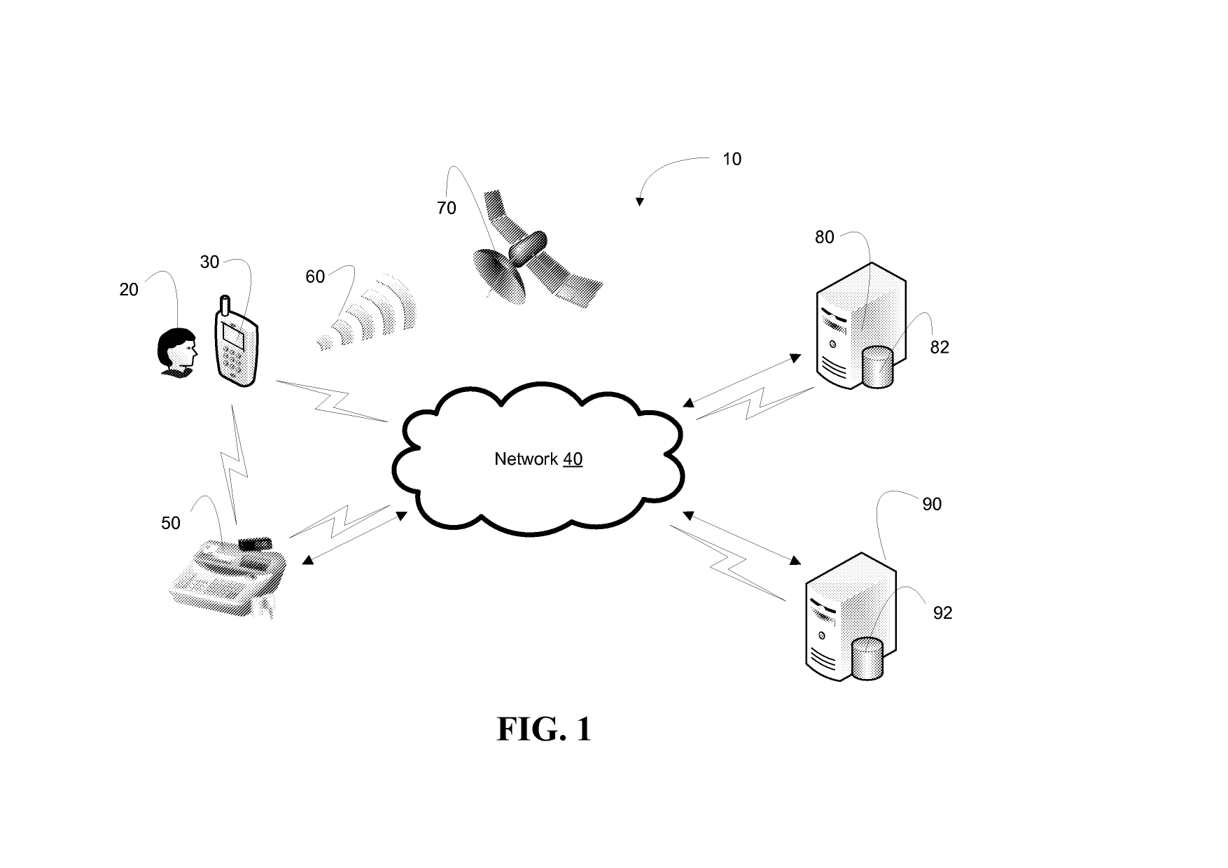

Referring to FIG. 1 a block diagram is provided of a system 10 for automatically activating mobile payment mechanisms in response to automated identification of mobile payment types accepted by a merchant; in accordance with embodiments of the present invention. The system 10 includes a user/consumer 20 in possession of a mobile communication device 30, such as a cellular/wireless telephone or the like configured to provide for wireless communication via network 40. In addition, mobile communication device 30 is configured to provide for conducting mobile payment (otherwise referred to as mobile wallet, mobile money, mobile money transfer and the like) implementing one, and in many instances more than one, mobile payment type (e.g., short-range wireless communication, image/code capture communication or the like). Mobile payment provides for the user's payment credentials (e.g., payment account number, authentication attributes and the like) to be wirelessly communicated from the mobile communication device or an intermediary (e.g., a cloud) to a corresponding Point-Of-Sale (POS) terminal 50 configured to accept mobile payment of the corresponding mobile payment type.

In accordance with embodiments of the invention, the mobile communication device 30 is configured to identify a merchant. In specific embodiments the mobile communication device is configured to automatically identify a merchant at which the user 20, in possession of the mobile communication device 30, is currently located or is proximate in location. In such embodiments, the mobile communication device includes a location-determining device, such as a Global Positioning System (GPS) device or the like, which provides for broadcasting signals 60 to a plurality of location-determining satellites 70 to determine the current location of the mobile communication device 30. The mobile communication device 30 is additionally in communication, via network 40, with a network device 80 that includes a mapping database 82 configured to identify the merchant located at or proximate to the current location of the mobile communication device 30.

In other embodiments of the invention, the merchant may be identified by user 20 input (via a mobile payment user-interface or the like) or the merchant may be identified by receipt of wireless communication or capture of images/codes which identify the merchant.

Once the merchant has been identified, the mobile communication device 30 determines one or more mobile payment types accepted by the merchant. Such a determination may be conducted by communicating, via network 40, with a network device 90 that stores a comprehensive mobile payment type database 92 that maps merchants to the mobile payment type(s) accepted by the merchant. The comprehensive database may be dynamically updated to reflect the current mobile payment types accepted by merchants. Such dynamic update may be accomplished via crowd sourcing (i.e., user/consumer inputs based on experience with a merchant), actual user/consumer transaction data, known merchant information provided by merchants or the like.

In other embodiments the determination of the mobile payment types accepted by a merchant may be conducted by accessing an internal mobile payment database (not shown in FIG. 1) stored locally on the mobile communication device. The internal mobile payment database may store mobile payment types for all merchants that the user 20 has previously conducted a mobile payment transaction. In one specific embodiment of the invention, determination of the mobile payment types accepted by a merchant may provide for accessing the internal mobile payment database and, if the internal database does not include currently include information pertaining to the merchant of interest, subsequently communicating with the network-based comprehensive mobile payment type database.

In response to determining one or more mobile payment types accepted by the merchant, the mobile communication device 30 automatically activates one or more mobile payment mechanisms, if the mobile communication device supports (includes the requisite hardware and/or software) at least one of the one or more mobile payment type(s) accepted by the merchant. In the event that the merchant only accepts one type of mobile payment, the mobile communication activates one or more mobile payment mechanisms (e.g., related hardware, software, firmware or the like) associated with the mobile payment type. For example, if the mobile payment type accepted by the merchant is of a short-range wireless communication type, such as NFC or like, activation of the mobile payment mechanisms includes activation of the short-range wireless device (e.g., an NFC chip) to allow for broadcasting the short-range wireless signals necessary for communicating payment credentials from the mobile communication device 20 to the POS terminal 50. In another example, if the mobile payment type accepted by the merchant is of an image capture type, such as QR code, barcode or the like, activation of the image capturing device (e.g., camera) and a related software application that displays a prompt directing the user 20 to capture the requisite image/code.

In those embodiments in which the merchant accepts two or more mobile payment types and the mobile communication device supports at least two of the mobile payment types, the mobile payment mechanisms activated may be predetermined by user configuration or merchant configuration, such that, the user 20 may prefer one mobile payment type versus other mobile payment types or the merchant may prefer that the user 20 use a preferred mobile payment type. In alternate embodiments, a user prompt may be displayed directing the user 20 to select from the two or more mobile payment types accepted by the merchant and, upon selection of a mobile payment type, automatic activation of the related mobile payment mechanisms occurs. Alternatively, a user prompt may be displayed directing the user to confirm the previously configured user preference or to override the previous preferred user preference and select from the two or more mobile payment types accepted by the merchant.

In the event that the merchant is determined to not accept any mobile payment or not accept a mobile payment type implemented by the mobile communication device, in lieu of activating mobile payment mechanisms, an alert, such as a prompt, audible signal or the like, may be communicated to the user via the mobile communication device, notifying the user that some other form of payment (cash, check, credit/debit card or the like) will need to be used to conduct a transaction with the merchant.

In most embodiments, automatic activation of the mobile payment mechanisms associated with a mobile payment type accepted by the merchant will not coincide with initiation of the mobile payment process. This is because in most embodiments, the user 20 will be required to take some other overt action, such as authorize payment, capture an image/code or the like to initiate or consummate the payment transactions. However, in other embodiments of the invention automatic activation of the mobile payment mechanisms may indeed initiate the mobile payment process.

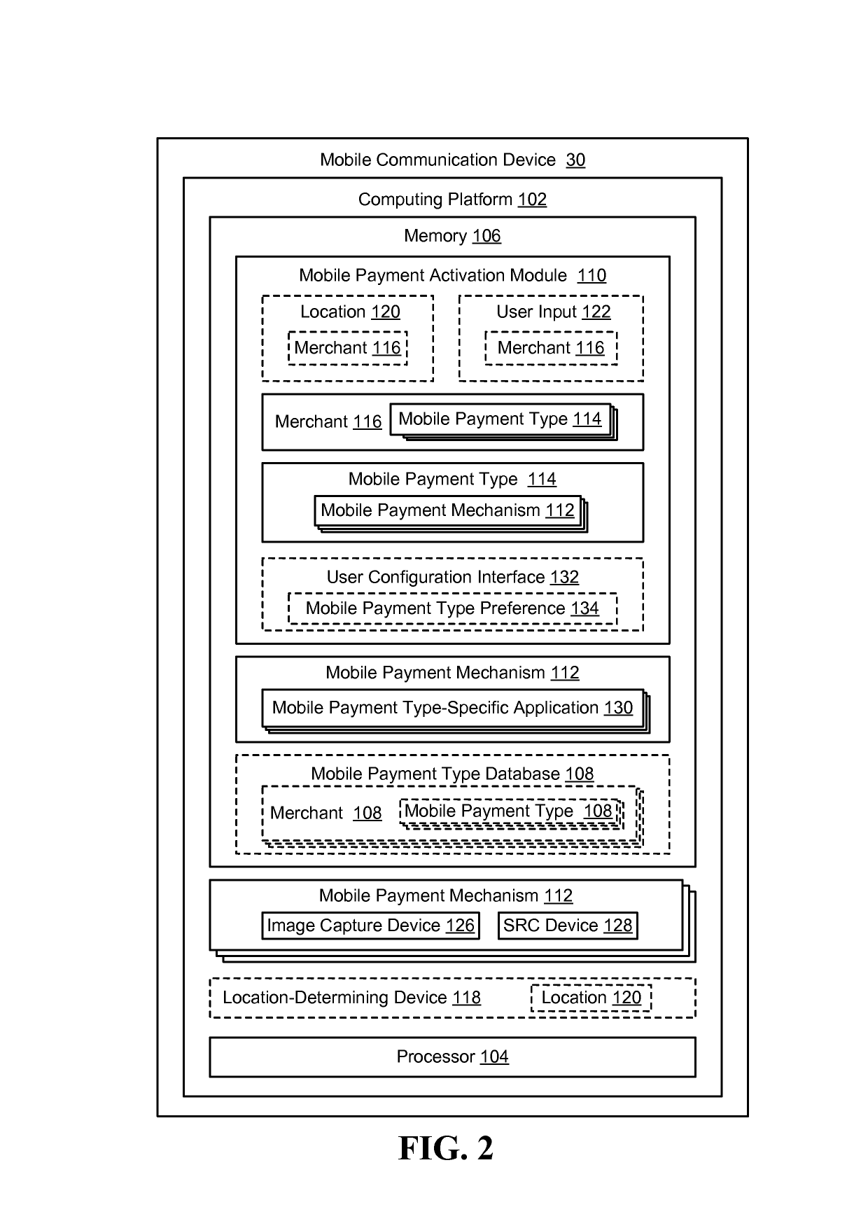

Referring to FIG. 2, a block diagram is depicted of an mobile communication device 30 configured for automatic activation of one or more mobile payment mechanisms in response to a determination of one or more mobile payment types accepted by a merchant, in accordance with embodiments of the present invention. The mobile communication device 30 includes a computing platform 102 having one or more processors 104 and a memory 106 in communication with the processor(s) 104. The memory 106 may comprise volatile and non-volatile memory, such as read-only and/or random-access memory (RAM and ROM), EPROM, EEPROM, flash cards, or any memory common to computer platforms. Further, memory 106 may include one or more flash memory cells, or may be any secondary or tertiary storage device, such as magnetic media, optical media, tape, or soft or hard disk.

Further, computing platform 102 also includes processor 104, which may be an application-specific integrated circuit (“ASIC”), or other chipset, processor, logic circuit, or other data processing device. Processor 104 or another processor such as ASIC may execute an application programming interface (“API”) (not shown in FIG. 2) that interfaces with any resident programs, such as mobile payment activation module 110 or the like stored in the memory 106 of the apparatus 100.

Processor 104 may include various processing subsystems (not shown in FIG. 2) embodied in hardware, firmware, software, and combinations thereof that enable the functionality of mobile communication device 30 and the operability of the device 30 on wireless network. For example, processing subsystems allow for initiating and maintaining communications and exchanging data with other devices in the network. For the disclosed aspects, processing subsystems of processor 104 may include any subsystem used in conjunction with mobile payment activation module 110 or subcomponents or sub-modules thereof.

The memory 106 of mobile communication device 30 includes mobile payment activation module 110 configured to automatically activate one or more mobile payment mechanisms 112 (e.g., software, hardware, firmware or the like) in response to identification of the mobile payment type(s) 114 accepted by a merchant 116, in accordance with embodiments of the present invention.

In addition, the mobile payment activation module 110 may be configured to identify a merchant 116 at which the user, in possession of the mobile communication device 30, is currently located or is proximate in location. In such embodiments, the mobile communication device 30 includes a location-determining device 118, such as a Global Positioning System (GPS) which provides for broadcasting signals to a plurality of location-determining satellites to determine the current location 120 of the mobile communication device 30. Once the current location 120 has been determined, the mobile payment activation module 110 or some other routine/module/application executable on the mobile communication device may identify the merchant 116 associated with the location. For example, the mobile communication device 30 may access a network-based mapping database (not shown in FIG. 2), which maps the geographic location to a merchant. In other embodiments of the invention the merchant 116 may be identified by other automated or non-automated means. For example, the mobile communication device 30 may be configured to receive wireless communication from the merchant that is configured to identify the merchant 116 or the user of the mobile communication device may capture images/codes at the merchant 116 that identifies the merchant 116. Additionally, the merchant 116 may be identified by user input 122 to a merchant-identifying user interface.

The mobile payment activation module 108 is further configured to identify the mobile payment type or types accepted by the merchant. In specific embodiments, the mobile payment activation module accesses a network-based mobile payment type database (not shown in FIG. 2) to determine the mobile payment type(s) accepted by the identified merchant. As previously noted the network-based mobile payment type database is a comprehensive database that may be configured for dynamic update to reflect the current mobile payment types accepted by merchants. Such dynamic update may be accomplished via crowd sourcing, actual user/consumer transaction data, known merchant information provided by merchants or the like.

In other specific embodiments, the memory 106 of mobile communication device includes mobile payment database 124 that stores information regarding the mobile payment type 114 accepted by various merchants 116. The mobile payment database 124 may be configured to automatically capture mobile payment type 114 information based on mobile payment transactions conducted by the user. In addition, the mobile payment database 124 may be configured to receive user inputs that indicate the mobile payment type(s) 114 accepted by a merchant 116 (regardless of whether the user has conducted a mobile payment with the merchant). In further specific embodiments of the module, determination of the mobile payment type(s) accepted by a merchant may provide for accessing the mobile payment database 124 to make a determination as whether the database 124 includes mobile payment type 114 information for the merchant 116 of interest and, if the database 124 does not include information pertaining to the merchant 116 of interest, subsequently communicating with the network-based comprehensive mobile payment type database to determine the mobile payment type(s) 114 accepted by the merchant 116 of interest.

The mobile payment activation module 108 is further configured to automatically activate one or more mobile payment mechanisms 112 associated with one of the mobile payment types 114 accepted by the identified merchant 116. The mobile payment mechanisms 112 may include hardware, such as image capture device 126, short-range communication device 128 or the like. Additionally, the mobile payment mechanisms 112 may include software (e.g., module, routines, applications, tools or the like), such as mobile-payment type-specific applications 130 each associated with a specific mobile payment type. For example, an image/code capture mobile payment application, a short-range wireless/NFC mobile payment application and the like. It should be noted that the mobile payment mechanisms shown and described are merely examples and, as such, the inventive concepts herein disclosed provide for automatically activating any known or future known mobile payment mechanisms as they pertain to a known or future-known mobile payment type.

The mobile payment activation module 110 may, in some embodiments, additionally include user configuration interface 132 configured to provide for the user to configure automatic activation of mobile payment mechanisms. In specific embodiments, the user configuration interface 132 is configured to allow the user to define mobile payment type preference(s) 134. Mobile payment type preferences 134 may provide for the user to define a preferred mobile payment type to be activated in the event the merchant accepts more than one mobile payment type. In other embodiments the module 110 may be configured to display a prompt (not shown in FIG. 2) on the mobile communication device prior to automatically activating the mobile payment mechanisms. The prompt may be configured to provide for the user to select from amongst two or more mobile payment types accepted by the merchant or to confirm or override the mobile payment type preference 134 previously configured by the user.

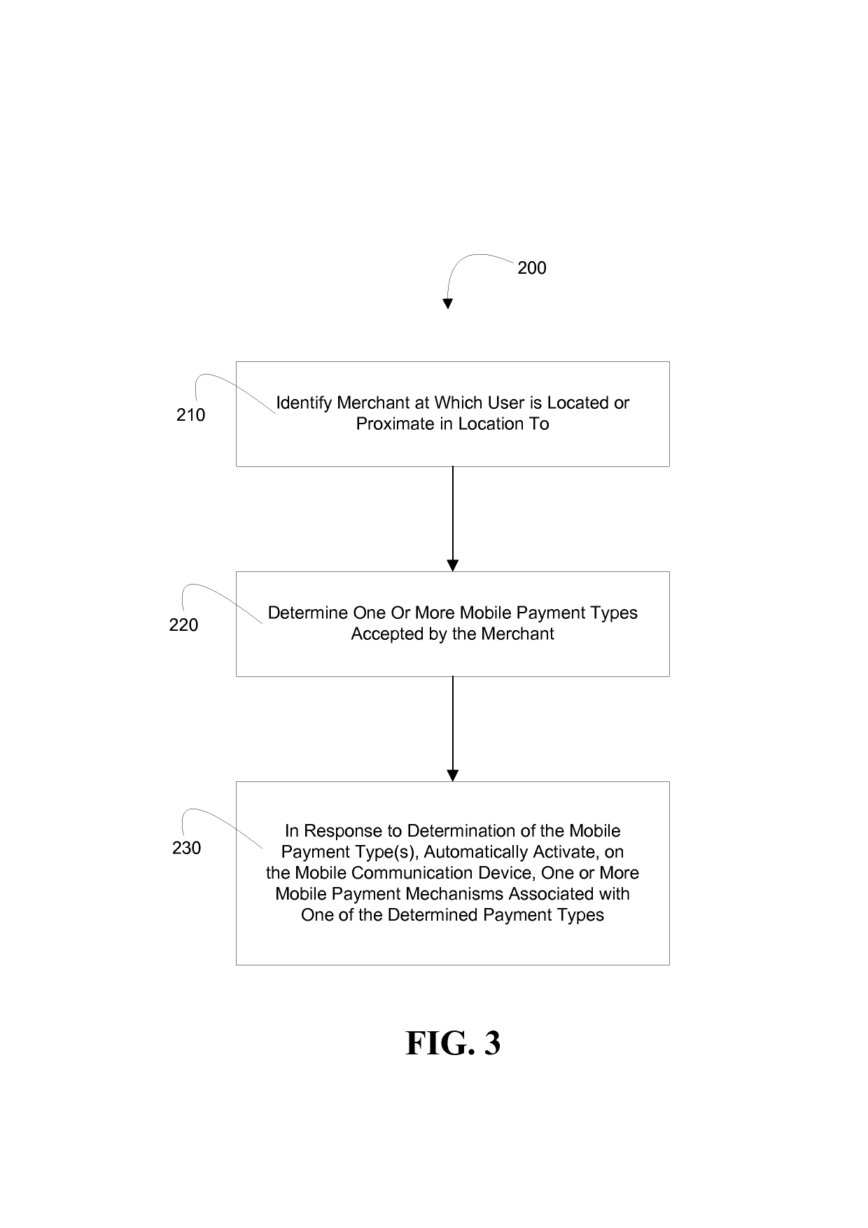

FIG. 3 is a high-level flow diagram of a method 200 for automatically activating mobile payment mechanisms in response to determination of the mobile payment type(s) accepted by a merchant. In accordance with embodiments of the present invention. At Event 210, a merchant is identified at which a user, in possession of a mobile communication device, is currently located or is close to in proximity. In such embodiments the mobile communication device may implement location-determining mechanisms to determine a geographic location of the device and access a database to identify a merchant located at the geographic location. In other embodiments of the invention, the merchant may be identified by user input.

At Event 220, one or more mobile payment types accepted by the identified merchant are determined. In certain embodiments, the determination of mobile payment type(s) accepted by the merchant is conducted by accessing a network-based mobile payment type database that is configured to map merchants to their known accepted merchant payment types. In other embodiments, the determination of mobile payment type(s) accepted by the merchant is conducted by accessing a locally-stored merchant payment type database on the mobile communication device. The locally-stored merchant payment type database may be configured to automatically store mobile payment type(s) accepted by a merchant based on a user conducting a mobile payment transaction with the merchant. In other embodiment, the determination of mobile payment type(s) accepted by the merchant may look first to the locally-stored merchant payment type database and, if the merchant payment type of the merchant of interest is not found in the locally-stored database, access the network-based merchant payment type database.

At Event 230, in response to determination of the mobile payment type(s) accepted by a merchant, one or more mobile payment mechanisms are automatically activated on the mobile communication device. For example, related mobile payment type-specific software/modules may automatically be launched and/or hardware may be activated. Such as image capture device, short-range-wireless device and the like. In the event that the merchant has been determined to accept more than one mobile payment type and the mobile communication device is configured to implement two or more of the mobile payment types accepted by the merchant, the user or the merchant may have predefined a preferred mobile payment type. In other embodiments of the method, a prompt may be displayed to the user prior to automatic activation of the mobile payment mechanisms, requiring the user select one of the mobile payment types accepted by the merchant, confirm a preference, or override a preference with a current selection of a mobile communication type.

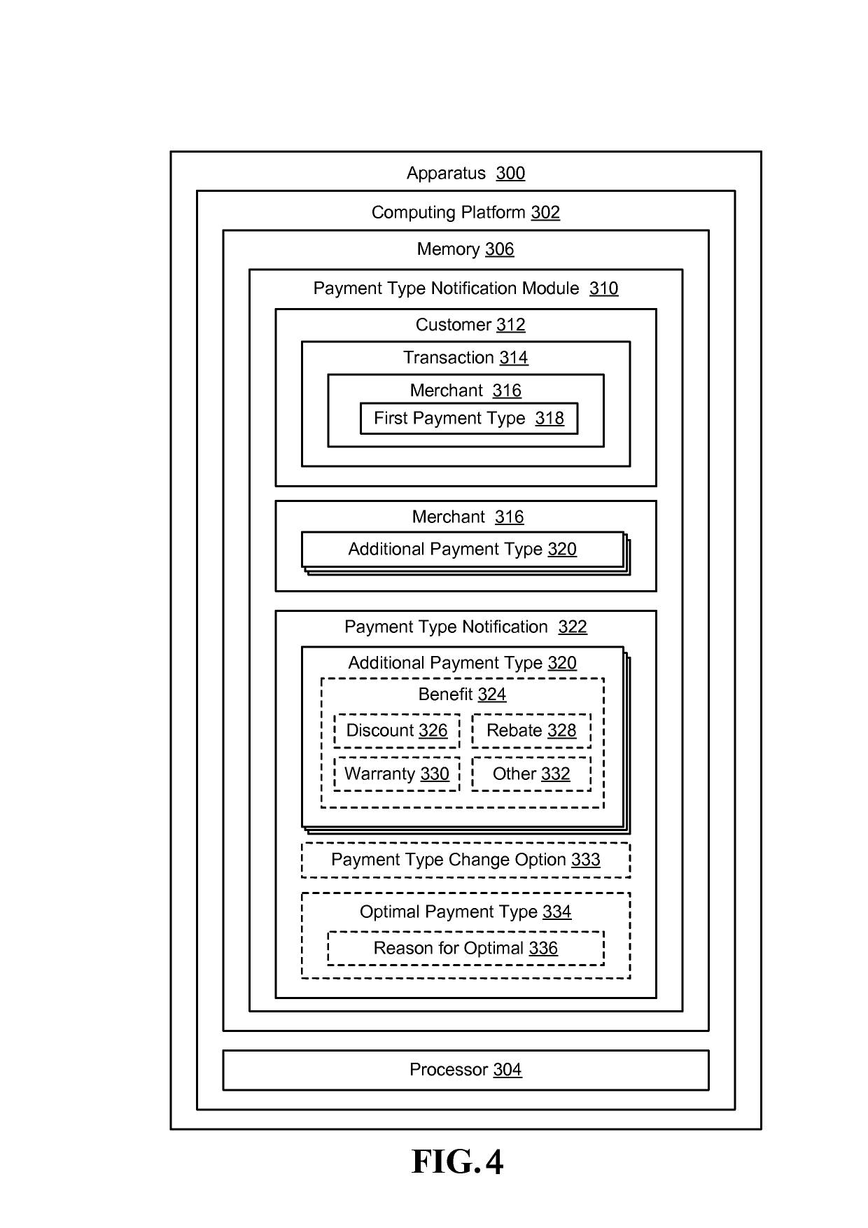

Referring to FIG. 4, a block diagram is depicted of an apparatus configured for notifying customers, post-transaction, of other payment types accepted by the merchant, in accordance with embodiments of the present invention. The notification may be communicated to the customer in addition to or in lieu of the previously described methodology for automatic activation of one or more mobile payment mechanisms in response to a determination of one or more mobile payment types accepted by a merchant. The apparatus 300, which may include one or multiple devices, includes a computing platform 302 having one or more processors 304 and a memory 106 in communication with the processor(s) 304. The memory 306 may comprise volatile and non-volatile memory, such as read-only and/or random-access memory (RAM and ROM), EPROM, EEPROM, flash cards, or any memory common to computer platforms. Further, memory 306 may include one or more flash memory cells, or may be any secondary or tertiary storage device, such as magnetic media, optical media, tape, or soft or hard disk.

Further, computing platform 302 also includes processor 304, which may be an application-specific integrated circuit (“ASIC”), or other chipset, processor, logic circuit, or other data processing device. Processor 304 or another processor such as ASIC may execute an application programming interface (“API”) (not shown in FIG. 4) that interfaces with any resident programs, such as payment type notification module 310 or the like stored in the memory 306 of the apparatus 300.

Processor 304 may include various processing subsystems (not shown in FIG. 4) embodied in hardware, firmware, software, and combinations thereof that enable the functionality of apparatus 300 and the operability of the apparatus 300 on a wire d and/or wireless network. For example, processing subsystems allow for initiating and maintaining communications and exchanging data with other devices in the network. For the disclosed aspects, processing subsystems of processor 304 may include any subsystem used in conjunction with payment type notification module 310 or subcomponents or sub-modules thereof.

The memory 306 of apparatus 300 includes payment type notification module 310 that is configured to notify a customer 312 of at least one additional payment type accept by a merchant after the customer has conducted a transaction with the merchant. Such notification serves to make the customer aware of payment types that they may have been otherwise unaware of their acceptance by the merchant. Such lack of knowledge of merchant acceptance may be especially prevalent amongst customers if the payment type is a new/emerging payment type, such as the mobile payment types discussed above.

In addition, such notification may, in some embodiments, include an option for the customer 312 to change the payment type in the just completed transaction to one of the additional payment types in the notification.

The payment type notification module 310 is configured to determine that a customer 312 has conducted a transaction 314 with a merchant 316 using a first payment type 318. In most embodiments, the payment type notification module is able to determine that the customer 312 has conducted a transaction 314 contemporaneous with the actual completion of the transaction. In such embodiments the module 310 is in communication with payment processing systems (not shown in FIG. 4), such as debit/credit card processing systems, check processing systems, mobile payment processing systems or the like, which provide the payment notification module 310 with customer-identifying information and transaction information including, but not limited to, the merchant 316 and the payment type 318 used to conduct the transaction. Payment type may include debit/credit card type (i.e., the card issuer or the financial institution issuing the card), check, mobile payment which may associated with different payment accounts (checking, savings, credit, credit card or the like), cloud payment or the like.

In addition, the payment type notification module 310 is configured to identify one or more additional payment types 320 accepted by the merchant 316, which are different than the first payment type 318. In such embodiments the payment type notification may be in communication with an internal or external database that maps merchants to payment types accepted. For example, the payment type notification module 310 may in communication with a network device (90 of FIG. 1) that stores a comprehensive mobile payment type database (92 of FIG. 1) that maps merchants to the payment type(s) accepted by the merchant. The comprehensive database may be dynamically updated to reflect the current payment types accepted by merchants. Such dynamic update may be accomplished via crowd sourcing (i.e., user/consumer inputs based on experience with a merchant), actual user/consumer transaction data, known merchant information provided by merchants or the like.

In response to identifying the additional payment types 320 accepted by the merchant 316, the payment type notification module 310 generates and initiates communication of a payment type notification 322 to the customer of at least one of the additional payment types 320. In one specific embodiment identification of additional payment types 320 may be limited to new/emerging payment types, such as mobile payment types and/or payment types not conventionally accepted by all merchants. In such specific embodiments the notification that is generated and communicated to the customer may be limited indicating only the new/emerging payment types, such as mobile payment types or the like and/or payment types not conventionally accepted by all merchants. While in other embodiments, the additional payment types identified may not be limited to new/emerging payment types, such as mobile payment types or the like and/or payment types not conventionally accepted by all merchants, but rather include all additional payment types, such as debit/credit card payment type, specific to card type, check, cash and the like.

In specific embodiments the notification is generated and communicated to the customer proximate in time to the customer completing the transaction that triggered the notification. In this regard, the customer may be notified of the additional payment types shortly after completing the transaction (e.g., within a few minutes at the most and in some embodiments within seconds of completing the transaction).

The notification may be communicated via any communication channel known or known in the future. Communication channels may include, but are not limited to, electronic mail (i.e., email), text or the like, which provide for the customer to receive the notification at a wireless communication device (e.g., mobile telephone or the like) proximate in time to the completion of the triggering transaction. In addition the notification may be sent and posted as an alert within the customer's mobile banking application, online banking application and/or mobile payment application or the like. In most embodiments of the invention, the customer is able to preconfigure which communication channel they desire as their communication channel of choice. In addition, the customer may configure which types of merchants they desire to be notified of additional payment types and/or which types/amounts of transactions may trigger notification of additional payment types.

In optional embodiments, the payment type notification 322 includes an a payment type change option 333 that is configured to allow the customer to change from the first payment type 318 to one of the additional payment types 320 for the just completed transaction 314. Certain payment types (e.g., certain cloud payments) characteristically have a lag time between when a transaction is completed and when the processing of the transaction payment begins, thus, allowing for the customer to change the payment type after completing the transaction.

In specific embodiments, the payment type notification 322 may include a payment type change option 333 for changing to credit payment type with an additional settle immediately option that provides for the financial institution to settle the credit transaction immediately (pay the credit provider) from a customer selected account (e.g., a Demand Deposit Account (DDA) or the like). Such embodiments of the invention allow for the customer to initially make a purchase using a payment type other than credit, for example a debit account payment and subsequently change to a credit account in order to realize the benefits afforded the credit account (e.g., rewards points, extended warranty coverage or the like) without having to incur interest on the credit charge and/or be burdened with the charge being due when the next credit statement issues. In other embodiments, the customer may pre-configure the module 310 to settle all credit payment type transactions immediately or all credit payment types transactions meeting a predefined amount threshold, thus obviating the need for the inclusion of the settle immediately option within the payment type notification 322.

In optional embodiments, the payment type notification module 310 may additionally be configured to determine a benefit 324 realized by the customer when using one of the additional payment types for the just completed transaction and/or a future transaction and include the benefit 324 in the payment type notification 322. For example, the benefit may include, but is not limited to, a discount 326, a rebate/cash-back 328, additional warranty coverage 330 or other benefit 332, such as rewards points or the like. Benefits may serve to entice the customer to use the additional payment type, especially a new/emerging payment type, for the current transaction, if a change option is provided, or for a future transaction at the currently-transacted merchant.

In certain embodiments of the invention, the benefit 324 associated with an additional payment type may be a generic benefit that is applicable to all customers. In such embodiments determination of the benefit of the benefit may be conducted by accessing a benefit database that maps benefits to payment type and merchant.

In other embodiment of the invention, the benefit 324 may be customer-specific. In such embodiments the module 310 may access customer data (not shown in FIG. 4), such as customer profile data, customer transaction history data, customer account data (both historical and current) and the like. The customer data itself may indicate benefits applicable to the customer or the module 310 may apply benefit rules (not shown in FIG. 4) to the data to determine the benefit applicable to the customer. For example, the customer's transaction history with the merchant may dictate the percent or dollar amount of the future discount for using the additional payment type.

In additional optional embodiments, the module 310 may determine an optimal payment type 334 for the currently completed transaction and/or similar future transactions from amongst the additional payment types 320 and, in some embodiments, the first payment type 318. In such embodiments, the payment type notification 322 may be configured to include the optimal payment type 334 and the reason for why the payment type is optimal (e.g., greater discount, greater rewards points, greater warranty protection and the like). The optimal payment type may be determined based on the benefits associated with each of the additional payment types 320, the item(s) purchased, the amount purchased and the like. In certain instances a payment type may offer greater warranty protection, thus if the item(s) in the currently processed transaction were electronic equipment, the optimal payment type for the current transaction and/or future similar transaction may be the payment type affording the greatest warranty protection. In another instance certain payment types may offer rewards/rewards points based on purchase amount, thus if the currently processed transaction is of a high purchase amount, the optimal payment type for the current transaction and/or future similar transactions may be the payment type affording the highest amount in rewards points.

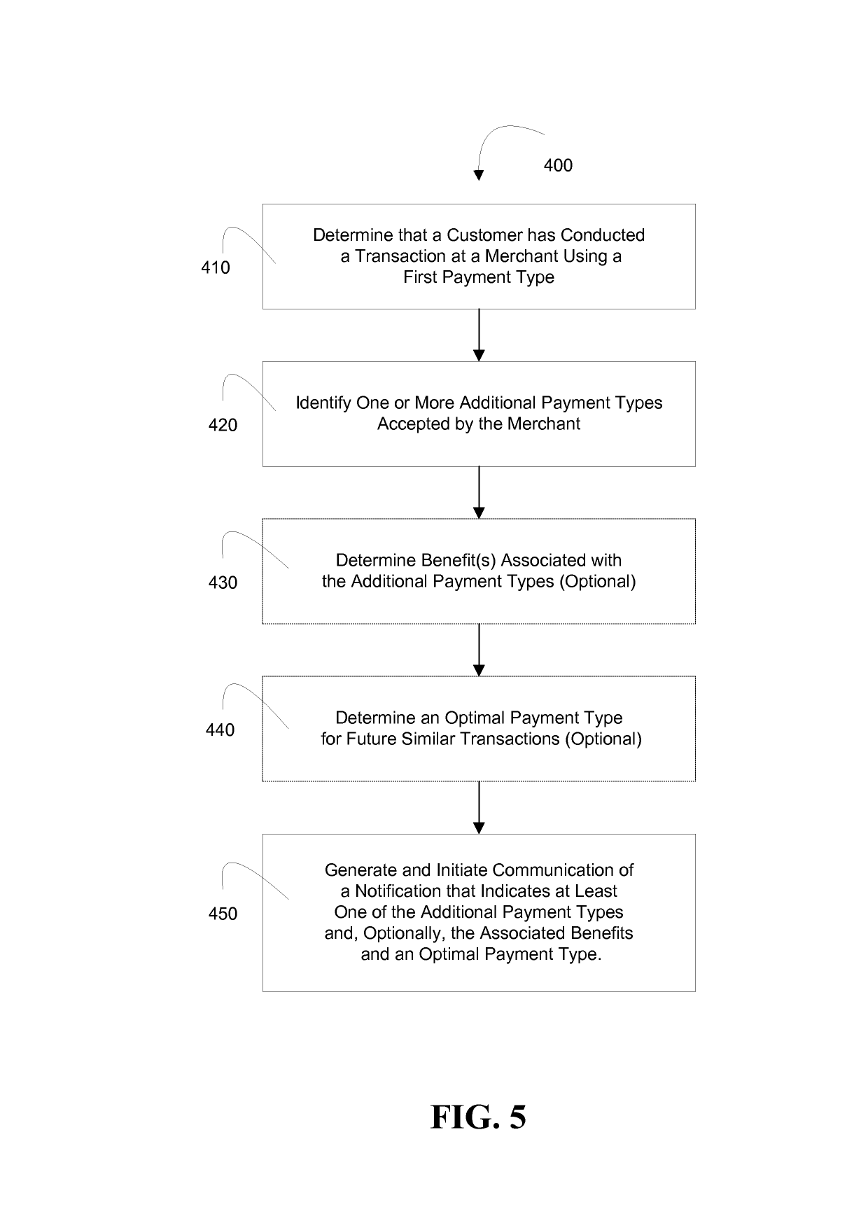

Referring to FIG. 5 a flow diagram is presented of a method 400 for notifying customers, post-transaction, of additional payment types accepted by a merchant, in accordance with embodiments of the present invention. At Event 410, a determination is made that a customer has conducted a transaction at a merchant using a first payment type. Such a determination is made by being in network communication with payment processing systems, such as a credit/debit card processing system, check processing/verification system, mobile payment processing system or the like, or in communication with customer transaction or account data, such as financial institution transaction data or account data. The determination that a customer has conducted a transaction at the merchant is configured to occur in real time or near real time to the completion of the transaction.

At Event 420, one or more additional payment types accepted by the merchant are identified. Identification of the additional payment types may occur by accessing a payment type database that maps merchants to payment types. In specific embodiments only certain types of additional payment types are identified, such as new/emerging payment types, e.g., mobile payment types or the like. While in other embodiments the method may be configured to identify all of the additional payment types accepted by the merchant.

At optional Event 430, one or more benefits associated with at least one of the identified additional payment types are determined. The benefit is accrued by the customer if they choose to use the associated payment type for the presently completed transaction, if a change option is provided, and/or for a future transaction with the merchant. The benefit may include, but is not limited to a percentage or amount discount, cash-back/rebate incentive, additional rewards points, additional warranty protection or the like. In specific embodiments in which the benefit is generic (i.e., applies to all customers), a benefit database is accessed which maps merchants and payment types to benefits. In other specific embodiments the benefit may be customer-specific, in such embodiments; data related to the customer may be accessed to determine the benefit. The customer data may include, but is not limited to, customer profile data, transaction history data, financial account data or the like. The customer data may store the benefit or the benefit may be determined by applying benefit rules to the customer data.

At optional Event 440, an optimal payment type is determined for the currently completed transaction and/or a future similar transaction. The optimal payment type may be limited to one or more of the additional payment types or it may include consideration of the first payment type used by the customer in conducting the currently completed transaction. The optimal payment type may be determined based on benefits associated with a payment type, the payment amount of currently completed transaction or the item(s) type in the currently completed transaction. Thus, the optimal payment type determined may be merchant-specific or may apply to any merchant which the customer chooses to use.

At Event 450, a notification that indicates at least one of the additional payment types accepted by the merchant is generated and communication of the notification to the customer is initiated. In optional embodiments, the notification may additionally indicate a benefit(s) associated with one or more of the additional payment types and/or the optimal payment type for the currently completed transaction and/or for future similar transactions.

In specific embodiments the notification includes a change option for the customer to change the payment type, in the just completed transaction, from the first payment type to one of the additional payment types indicated in the notification. In such embodiments the notification may be configured to receive a customer input, via link or the like, that initiates the change from the first payment type to a select additional payment type.

In other specific embodiments, the notification is generated and communicated proximate in time to completion of the triggering transaction, such that the customer will generally receive the transaction. In specific embodiments the customer may configure the notification system to send the notifications via chosen communication channel, such as email, text or the like. Additionally, the notifications may be configured to be communicated as alerts that post within a mobile banking application, an online banking application, a mobile payment application or the like. In addition, the notifications may be communicated as part of the payment receipt (e.g., hard copy or electronic) received by the customer for the currently completed transaction.

Thus, apparatus, methods and computer program products are described above that provide for notifying customers, post-transaction of additional payment types accepted by the merchant. As such, the present invention serves to make the customer aware of new and emerging payment types, such as specific mobile payment types, that the customer may otherwise be unaware of their acceptance by the merchant. In addition, the notification may provide an option for the customer to change the payment type of the just completed transaction to one of the additional payment types indicated in the notification. In addition, the merchant, via the notification, may provide benefits (e.g., discounts, rebates/cash-back or the like) to the customer for using one of the additional payment types for a future transaction, thereby, enticing the customer to use the new and emerging payment type. Moreover, in those embodiments in which the notification of additional payment types includes an optimal payment type, the customer benefits from being provided information as to which payment type should be used in the future so as to optimize the customer's transaction in terms of benefits or the like.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for notifying customers of payment types accepted by a merchant, the apparatus comprising:
a computing platform including a memory and at least one processor in communication with the memory; and
a payment type notification module stored in the memory, executable by the processor and configured to:
determine that a customer has conducted a transaction with a merchant using a first payment type;
identify one or more additional payment types accepted by the merchant, wherein each additional payment type is different than the first payment type; and
in response to identification of the one or more additional payment types, generate and communicate a notification to the customer that indicates at least one of the additional payment types.

2. The apparatus of claim 1, wherein the payment type notification module is further configured to generate and communicate the notification to the customer that includes an option to change the first payment type to one of the additional payment types for the transaction.

3. The apparatus of claim 2, wherein the payment type notification module is further configured to receive a customer input that initiates a change from the first payment type to one of the additional payment types for the transaction.

4. The apparatus of claim 1, wherein the payment type notification module is further configured to identify at least one mobile payment type included in the one or more additional payment types and, in response to determination of the at least one mobile payment type, generate and communicate a notification to the customer that indicates the at least one mobile payment type.

5. The apparatus of claim 1, wherein the payment type notification module is further configured to determine a benefit to be realized by the customer using one of the additional payment types and, in response to determination of the benefit, generate and communicate the notification to the customer that further indicates the benefit associated with an additional payment type indicated in the notification.

6. The apparatus of claim 5, wherein the payment type notification module is further configured to determine a customer-specific benefit to be realized by the customer using the additional payment type.

7. The apparatus of claim 5, wherein the payment type notification module is further configured to determine a benefit realized by the customer using one of the additional payment types, wherein the benefit is one or more of a discount with the merchant, a cash-back incentive with the merchant, or additional warranty coverage.

8. The apparatus of claim 1, wherein the payment type notification module is further configured to determine an optimal payment type from amongst the one or more additional payment types.

9. The apparatus of claim 8, wherein the payment type notification module is further configured to, in response to determination of the optimal payment type, generate and communicate the notification to the customer that indicates the optimal payment type and a reason why the optimal payment type is optimal.

10. The apparatus of claim 1, wherein the payment type notification module is further configured to determine an optimal payment type from amongst the one or more additional payment types, wherein the optimal payment type is based on one of one or more item types in the transaction or a payment amount for the transaction.

11. The apparatus of claim 1, wherein the payment type notification module is further configured to generate and communicate the notification to the customer proximate in time to the transaction.

12. A method for notifying customers of payment types accepted by a merchant, the method comprising;
determining, by a computing device processor, that a customer has conducted a transaction with a merchant using a first payment type;
identifying, by a computing device processor, one or more additional payment types accepted by the merchant, wherein each additional payment type is different than the first payment type; and
in response to identification of the one or more additional payment types, generating and initiating communication, by a computing device processor, of a notification to the customer that indicates at least one of the additional payment types.

13. The method of claim 12, wherein generating further comprises generating and initiating communication, by a computing device processor, of the notification that includes an option to change the first payment type to one of the additional payment types for the transaction.

14. The method of claim 13, further comprises receiving a customer input that initiates a changes from the first payment type to one of the additional payment types for the transaction.

15. The method of claim 12, wherein identifying one or more additional payment types further comprises determining, by the computing device processor, at least one mobile payment type and wherein generating and initiating communication further comprises, in response to determination of the at least one mobile payment type, generating and initiating communication, by the computing device processor, of a notification to the customer that indicates the at least one mobile payment type.

16. The method of claim 12, further comprising determining, by a computing device processor, a benefit to be realized by the customer using one of the additional payment types and wherein generating and initiating communication further comprise generating and initiating, in response to determination of the benefit, the notification to the customer that further indicates the benefit associated with the additional payment type indicated in the notification.

17. The method of claim 16, wherein determining the benefit further comprises determining, a customer-specific benefit to be realized by the customer using the additional payment type.

18. The method of claim 16, wherein determining the benefit further comprises determining the benefit realized by the customer using one of the additional payment types, wherein the benefit is one or more of a discount with the merchant, a cash-back incentive with the merchant, or additional warranty coverage.

19. The method of claim 12, further comprising determining, by a computing device processor, an optimal payment type from amongst the one or more additional payment types.

20. The method of claim 19, further comprising, in response to determination of the optimal payment type, generating and initiating communication, by the computing device processor, of the notification to the customer that indicates the optimal payment type and a reason why the optimal payment type is optimal.

21. The method of claim 19, wherein determining the optimal payment further comprises, determining, by the computing device processor, the optimal payment type based on one of one or more item types in the transaction or a payment amount for the transaction.

22. The method of claim 12, wherein generating and initiating communication further comprises generating and initiating communication, by the computing device processor, of the notification to the customer proximate in time to the transaction.

23. A computer program product comprising a non-transitory computer-readable medium comprising:
a first set of codes for causing a computer processor device to determine that a customer has conducted a transaction with a merchant using a first payment type;
a second set of codes for causing a computer processor device to identify one or more additional payment types accepted by the merchant, wherein each additional payment type is different than the first payment type; and
a third set of codes for causing a computer processor device to, in response to identification of the one or more additional payment types, generate and initiate communication of a notification to the customer that indicates at least one of the additional payment types.

24. The computer program product of claim 23, wherein the third set of codes is further configured to cause the computer processor device to generate and initiate communication of the notification to the customer that includes an option to change the first payment type to one of the additional payment types for the transaction.

25. The computer program product of claim 24, further comprising a fourth set of codes for causing the computer processor device to receive a customer input that initiates a change from the first payment type to one of the additional payment types for the transaction.

26. The computer program product of claim 23, wherein the second set of codes is further configured to cause the computer processor device to identify at least one mobile payment type and wherein the third set of codes is further configured to cause the computer processor device to generate and initiate communication of a notification to the customer that indicates the at least one mobile payment type.

27. The computer program product of claim 23, further comprising fourth set of codes for causing a computer processor device to determine a benefit to be realized by the customer using one of the additional payment types and wherein the third set of codes is further configured to cause the computer processor device to generate and initiate communication, in response to determination of the benefit, the notification to the customer that further indicates the benefit associated with the additional payment type indicated in the notification.

28. The computer program product of claim 27, wherein the fourth set of codes is further configured to cause the computer processor device to determine a customer-specific benefit to be realized by the customer using the additional payment type.

29. The computer program product of claim 27, wherein the fourth set of codes is further configured to cause the computer processor to determine the benefit realized by the customer using one of the additional payment types, wherein the benefit is one or more of a discount with the merchant, a cash-back incentive with the merchant, or additional warranty coverage.

30. The computer program product of claim 23, further comprising a fourth set of codes for causing a computer processor device to determine an optimal payment type from amongst the one or more additional payment types.

31. The computer program product of claim 30, wherein the third set of codes is further configured to cause the computer processor device to, in response to determination of the optimal payment type, generate and initiate communication of the notification to the customer that indicates the optimal payment type and a reason why the optimal payment type is optimal.

32. The computer program product of claim 30, wherein the fourth set of codes is further configured to cause the computer program product to determine the optimal payment type based on one of one or more item types in the transaction or a payment amount for the transaction.

33. The computer program product of claim 23, wherein the third set of codes is further configured to cause the computer processor device to generate and initiate communication of the notification to the customer proximate in time to the transaction.
